(19) United States
(12) Patent Application Publication
(10) Pub. No.: US 2009/0138291 A1
(43) Pub. Date: May 28, 2009

(54) Systems, Methods and Devices for Online Reservation Inquiries

(75) Inventor: Michael Heinze, Zell am See (AT)

Correspondence Address: HOFFMANN & BARON, LLP, 6900 JERICHO TURNPIKE, SYOSSET, NY, 11791, US

(73) Assignee: HETRAS GMBH, Zell am See (AT)

(21) Appl. No.: 12/269,958

(22) Filed: Nov. 13, 2008

(30) Foreign Application Priority Data
Nov. 26, 2007 (AT) GM 716/2007

(51) Int. Cl. G06Q 10/00; G06T 15/00

(52) U.S. Cl. 705/5; 345/419

(57) ABSTRACT

The present invention pertains to systems, methods and devices for online reservation inquiries of individual shares of an item. The system has a server that makes available a 3D graphic model of the item as well as reservation statuses of the shares of the item for inquiries, and a client computer for displaying the 3D graphic model on a user screen from an arbitrarily changeable perspective. The 3D graphic model of the item contains a graphic object for each share that is spatially related to this share in the 3D graphic model. The server transmits the 3D graphic model of the item and the reservation statuses of the shares of the item to the client computer in response to respective inquiries. The manner in which each graphic object is displayed in the arbitrarily changeable perspective of the 3D graphic model is defined by the reservation status of the share to which it is related.

This application claims the benefit of Austrian Application Serial No. GM 716/2007 filed on Nov. 26, 2007, the disclosure of which is incorporated herein by reference.

### TECHNICAL FIELD

The present invention pertains to systems, methods and devices for online reservation inquiries of individual shares of an item, particularly the rooms of a hotel.

### BACKGROUND OF THE INVENTION

Online reservation systems of the above-described type are known, for example, from JP 2004-29937 A and make it possible to take a realistic “virtual tour,” e.g., of a hotel, its rooms or the surroundings of the hotel by displaying 3D graphic models of the hotel, the rooms, the surroundings, etc., on a user screen from an interactively changeable perspective (“virtual reality”). Dedicated booking systems with conventional text-bound search masks are used for the reservation inquiry of individual rooms and output lists of the available rooms. Consequently, the inquiry is time-consuming for the user, and the user himself must interpret information on available reservations obtained during the inquiry and, in particular, relate this information to the actual local circumstances.

### SUMMARY OF THE INVENTION

The invention is based on the objective of developing systems, methods and devices that overcome the above-described disadvantages and, in particular, make it possible to carry out particularly simple and fast online reservation inquiries that can also be easily interpreted.

According to a first aspect, this objective is realized with a system for online reservation inquiries of individual shares of an item, comprising:

a server that makes available a 3D graphic model of the item as well as reservation statuses of the shares of the item for inquiries, and

a client computer for displaying the 3D graphic model on a user screen from an arbitrarily changeable perspective,

wherein the 3D graphic model of the item contains a graphic object for each share that is spatially related to this share in the 3D graphic model,

the server transmits the 3D graphic model of the item and the reservation statuses of the shares of the item to the client computer in response to respective inquiries, and

the manner in which each graphic object is displayed in the arbitrarily changeable perspective of the 3D graphic model is defined by the reservation status of the share to which it is related.

In this way, the reservation statuses of individual shares are spatially linked to objects in the 3D graphic model such that the user is able to immediately ascertain the available reservations in the interactively manipulatable 3D graphic model. Consequently, the user can directly determine the layout of shares that can be reserved, e.g., rooms in the virtual reality of the 3D graphic model, and therefore no longer needs to establish the spatial relations himself. In comparison with systems known thus far, the system according to the invention allows a simpler, faster and more intuitive online inquiry of available reservations.

In a first preferred embodiment of the invention, the graphic object related to the share represents itself in the 3D graphic model. This minimizes the number of objects in the 3D graphic model that must be interpreted by the client computer. Alternatively, the graphic object related to the share may be located directly adjacent to a graphic representation of this share in the 3D graphic model; it is then unnecessary to modularize the 3D graphic model into individual graphic representations of each share; the graphic objects related to the shares might also be realized more simply than the graphic representations of the shares.

The aforementioned form of display in dependence on the reservation status preferably concerns the visibility, transparency or color of the graphic object. The color or transparency (“degree of transparency”) as the form of display is particularly suitable for graphic objects that represent the respective share themselves in the 3D graphic model. The visibility (“visible” or “invisible”) is particularly suitable for graphic objects that are located adjacent to, but do not completely cover the graphic representation of a share, e.g., for “floating tags.” The visibility and the transparency as the form of display are particularly suitable for graphic objects that are located closely adjacent to the graphic representation of a share and completely cover or even envelope this graphic representation.

According to another preferred characteristic of the invention, the aforementioned form of display is also sensitive to a mouse pointer. The form of display of a graphic object can change when the mouse pointer is moved over this graphic object (“mouse over”) such that the current user selection of a graphic object can also be optically displayed.

In any case, it is advantageous if an inquiry regarding the reservation statuses of certain attributes of the shares can be carried out in dependence on and with respect to certain attributes in accordance with another characteristic of the invention. Such attributes may consist, for example, of the number of beds, amenities such as a bath/shower, ocean view, half-board, etc., according to which the reservation statuses can be filtered during the inquiry.

At this point, it should be noted that the term “reservation status” used in this context includes any type of availability information on a share, e.g., simple boolean information such as “in stock/out of stock,” “available/not available,” “vacant/not vacant” or additional qualitative and/or quantitative information such as “special offer”, certain reservation conditions (e.g., “can only be booked until . . . ”, “can only be booked for . . . ”), etc.

It is particularly advantageous if the reservation statuses are divided into time units and inquiries with respect to certain time windows of time units can be carried out in accordance with another preferred characteristic of the invention. This allows a time-interactive reservation inquiry in addition to a space-interactive reservation inquiry: the time window can be interactively adjusted on the user screen, for example, with the aid of a sliding scale object, a rotary dial object or a calendar object, etc., and the 3D graphic model is updated as a function of the adjusted time window and the corresponding reservation inquiry. The perspective of the 3D graphic model with the reservation status-dependent graphic objects can still be selected arbitrarily in an interactive fashion such that it is possible to realize a quasi-spatiotemporal (“4-dimensional”) overview of the reservation status of the shares of the item, e.g., the room occupancy of a hotel.

According to another preferred embodiment of the invention, the graphic object displayed on the user screen is sensitive to mouse pointers in order to initiate a reservation. For example, the user can click on the graphic object related to a share that can be reserved in order thereby to launch an online reservation or booking.

According to a second aspect of the invention, a first method is proposed for online reservation inquiries of individual shares of an item, comprising the steps of:

making available a 3D graphic model of the item, which 3D model can be displayed on a user screen from an arbitrarily changeable perspective and contains a graphic object for each share that is spatially related to this share in the 3D graphic model, on a server,

making available reservation statuses of the shares on the server,

transferring the 3D graphic model and the reservation statuses from the server to a client computer in response to a respective inquiry,

defining the manner of display of each graphic object in accordance with the reservation status of the share to which it is related, in the client computer, and

displaying the 3D graphic model on the user screen of the client computer from an arbitrarily changeable perspective.

Alternatively, a second method is proposed for online reservation inquiries of individual shares of an item, comprising the steps of:

making available a 3D graphic model of the item, which 3D model can be displayed on a user screen from an arbitrarily changeable perspective and contains a graphic object for each share that is spatially related to this share in the 3D graphic model, on a server,

making available reservation statuses of the shares on the server,

defining the manner of display of each graphic object in accordance with the reservation status of the share to which it is related, in the server,

transferring the 3D graphic model with the graphic objects so defined from the server to a client computer, and

displaying the 3D graphic model on a user screen of the client computer from an arbitrarily changeable perspective.

Both variants of the method result in the advantages that were already described above with respect to the system, wherein the first variant provides the special advantage of reduced network traffic and the second variant provides the special advantage of fewer arithmetic operations on the client computer.

According to a third aspect, the invention proposes a server for online reservation inquiries of individual shares of an item,

the server making available a 3D graphic model of the item that can be displayed on a user screen from an arbitrarily changeable perspective and reservation statuses of the shares of the item for inquiries,

wherein the 3D graphic model of the item contains a graphic object for each share that is spatially related to this share in the 3D graphic model,

wherein the manner in which each graphic object is represented in the 3D graphic model is respectively defined by the reservation status of the share to which it is related.

According to a fourth aspect, the invention proposes a client computer for online reservation inquiries of individual shares of an item,

the client computer receiving, upon a respective inquiry, a 3D graphic model of the item as well as reservation statuses of the shares of the item from a server and displaying the 3D graphic model on a user screen from an arbitrarily changeable perspective,

wherein the 3D graphic model of the item contains a graphic object for each share that is spatially related to this share in the 3D graphic model, and

the manner in which each graphic object is displayed in the arbitrarily changeable perspective of the 3D graphic model is defined by the reservation status of the share to which it is related.

With respect to preferred embodiments of the inventive methods, server and client computers it is analogously referred to the above-described variants of the system and their advantages.

### BRIEF DESCRIPTION OF THE DRAWINGS

The invention is described in greater detail below with reference to embodiments that are illustrated in the enclosed drawings. In the drawings show

FIG. 1 the system and the server according to the invention in the form of a schematic block diagram;

FIG. 2 a perspective representation of an example of an item with individual shares that can be reserved, namely a hotel with rooms;

FIG. 3 the structure of the reservation status database of the server according to FIG. 1;

FIG. 4 a perspective exploded view of the structure of an exemplary 3D graphic model of the graphic model database of the server according to FIG. 1, namely with three different variants of graphic objects that are spatially related to individual shares of the item according to FIG. 2, and

FIGS. 5-7 exemplary screen displays on the user screen of a client computer in different stages of the inventive method.

### DESCRIPTION OF THE PREFERRED EMBODIMENTS

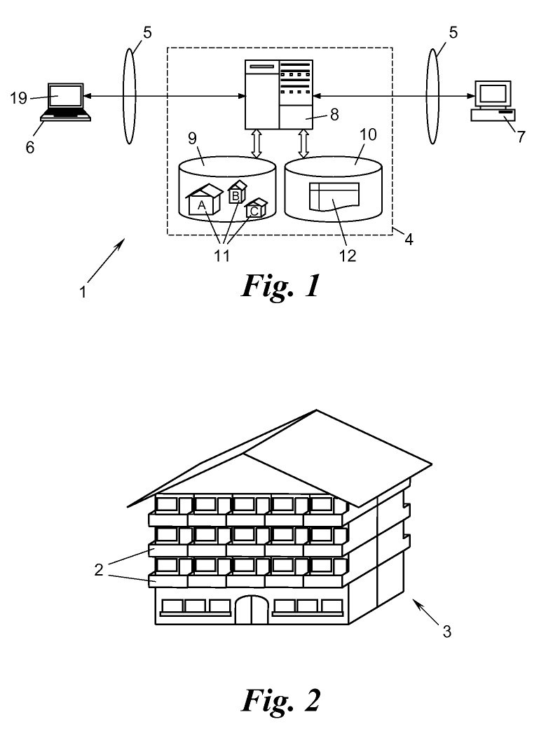

The system 1 shown in FIG. 1 serves for carrying out an online reservation inquiry of individual shares 2 of an item 3 that is illustrated in FIG. 2, for example, in the form of a hotel, the rooms of which form the shares 2.

The system 1 comprises a server, preferably a web server 4, that is connected to client computers 6 (of which only one representative client computer is shown) and hotelier terminals 7 (of which only one representative terminal is shown) via a data network, preferably the Internet 5. The web server 4, in turn, comprises a computer 8 and two databases 9, 10 that are connected to this computer and, if applicable, may be arranged in a geographically remote location relative to the computer 8 and connected thereto, for example, via the Internet 5.

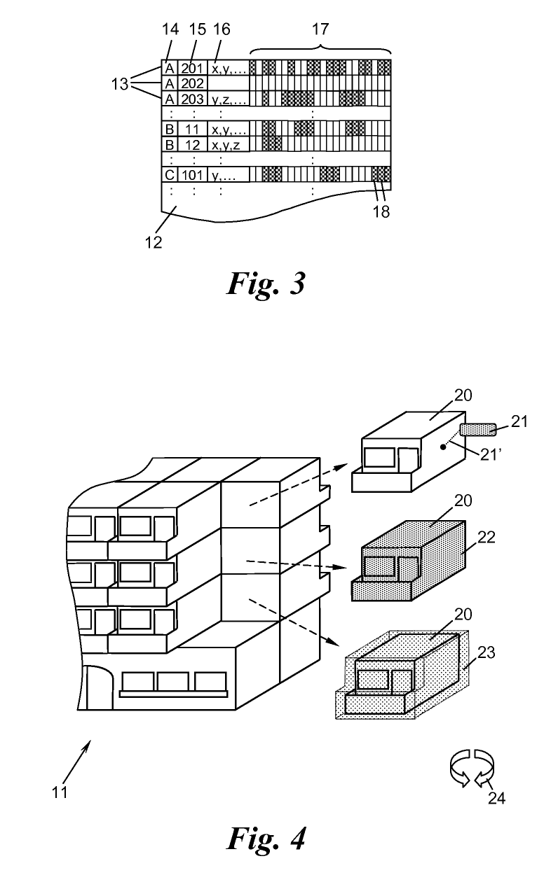

The first database 9 contains 3D graphic models 11 of items 3 that are described in greater detail below with reference to FIGS. 4-7. The second database 10 contains the reservation statuses of the shares 2 of the items 3, e.g., in the form of a list 12, the structure of which is illustrated more clearly in FIG. 3.

According to FIG. 3, the list 12 contains an entry 13 for each share 2 of an item 3: an identifier 14 of the item 3, an identifier 15 of the share 2, a list 16 with attributes that characterize certain properties of the share 2 such as size, availability, services associated with the share, etc., as well as a reservation status 17 of the share 2 with respect to individual time units 18.

The reservation status 17 of the share 2 in a time unit 18 may not only contain simple boolean information (e.g., vacant/not vacant), but also additional qualitative and/or quantitative information, e.g., on special offers, certain reservation conditions (“can only be booked in connection with . . . ,” “can only be booked for . . . ,” “can only be booked if . . . ”, etc.). All this information is combined under the general term “reservation status.”

The reservation statuses 17 of the shares 2 of the items 3 are fed to the availability database 10 by hoteliers from the hotelier terminals 7 or by automatic reservation or booking systems.

The users are able to carry out conventional inquiries regarding the reservation statuses 17 at the client computers 6, e.g., by means of corresponding screen masks and customary client/server inquiry techniques, wherein the result of these inquiries can be output in conventional text or table form on the user screen 19.

In addition to these known inquiry options of the availability database 10, a spatially and temporarily dynamic 3D visualization of the reservation statuses 17 of the shares 2 of a certain item 3 is also generated for a user on the client computer 6, namely by linking the information of the availability database 10 to that of the graphic model database 9 in the manner described below.

According to FIG. 4, the graphic model 11 of the item 3 contains a graphic object for each of its shares 2 that is spatially related precisely to this share in the 3D graphic model 11. FIG. 4 shows three different embodiments 21-23 of graphic objects that are representative of the graphic objects of all shares 2. The graphic objects 21-23 are removed from their locations in the 3D graphic model 11 (exploded view) that are indicated by arrows drawn with broken lines in order to provide a better overview.

The form of representation of a graphic object 21-23 in the 3D graphic model 11 displayed on the user screen 19, i.e. hence its manner of display, is controlled from the availability database 10 based on the reservation status 17 of the share 2 to which it is related. This can either be realized with the computer 8 of the web server 4 during the transmission of the 3D graphic model 11 to the client computer 6 or by the client computer 6 if it receives the reservation statuses 17 from the web server 4 separately.

The form of display of the graphic objects 21-23 that is controlled as a function of the reservation status may concern, in particular, its visibility, transparency or color, but also its texture, resolution, movement, etc.

In a first embodiment 21 of the graphic object, said graphic object is realized, e.g., in the form of a two-dimensional or three-dimensional, opaque or semitransparent tag and is spatially arranged in the immediate vicinity of a graphic representation 20 of the share 2 to which it is related, in the 3D graphic model 11. The graphic object 21 consists, e.g., of a “floating tag” and may be optionally “connected” to the graphic representation 20 with a reference line 21′. If the perspective of the 3D graphic model 11 on the user screen 19 is varied, e.g., in the form of a rotation in the direction of the arrows 24, the graphic object 21 with the graphic representation 20 of the share 2 also moves accordingly in the 3D graphic model 11. The visibility, color and/or textual content of the graphic object 21 reflects the reservation status 17 of the share 2, to which it is related.

In an alternative embodiment 22 of the graphic object, the graphic object 22 corresponds to the graphic representation 20 of the share 2. In this case, the reservation status 17 of the share 2 defines, e.g., the color, texture, transparency, etc, of the graphic object 22 in the interactively rotatable 3D graphic model 11 displayed on the user screen 19.

In another alternative embodiment 23 of the graphic object, said graphic object is realized in the form of a semitransparent envelope that spatially encloses or at least partially covers the graphic representation 20 of the share 2, to which it is related, and thus causes a corresponding color change in the graphic representation 20. Here, the reservation status 17 of the share 2 defines, e.g., the degree of transparency of the graphic object 23 or its visibility, i.e., whether or not it is displayed.

The embodiments 21 and 23 of the graphic objects do not require the graphic representation 20 of the share 2 to be actually present in the form of a separate object in the 3D graphic model 11; for example, the entire item 3 may be modeled in a single object of the 3D graphic model 11 since the graphic objects 21 and 23 merely must be spatially related to the location of the respective share 2 in the 3D graphic model 11. In the embodiment 22 of the graphic object, the 3D graphic model 11 must be modularized into individual graphic representations 20 for each share 2.

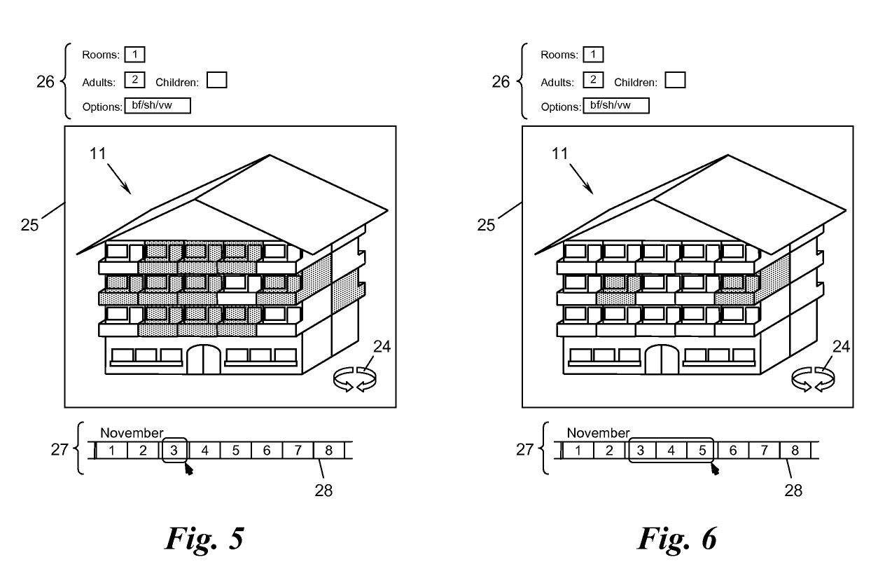

FIGS. 5-7 respectively show the function of the system 1 and the sequence of the method according to the invention in the form of an exemplary representation on the user screen 19 of the client computer 6, e.g., in the form of an Internet page retrieved from the web server 4. A suitable display module, e.g., a browser applet in the client computer 6 displays the 3D graphic model 11 of the item 3 that was received from the web server 4 in a display area 25 of the user screen 19 from an arbitrarily changeable perspective as represented by the arrows 24, i.e., the user can dynamically alter the perspective, e.g., rotate and view the 3D graphic model 11 from all sides by means of corresponding mouse movements or keyboard commands.

The user can input certain search criteria and time windows for the inquiry of the web server 4 in an attribute selection area 26 and a time window selection area 27 of the user screen 19, wherein the web server subsequently returns the reservation statuses 17 of the shares 2 of the item 3, the 3D graphic model 11 of which is currently displayed in the screen area 25, to the client computer 6 after they were filtered in accordance with these search and selection criteria, e.g., in the form of XML text that forms part of an HTTP response as shown below:

```
< AvailableRooms>
    <AvailableRoom>101</AvailableRoom>
    <AvailableRoom>102</AvailableRoom>
    <AvailableRoom>210</AvailableRoom>
<AvailableRooms>
```

The client computer 6 forwards the response from the web server 4 to its display module, for example, in the form of corresponding function calls to the Java applet that displays the 3D graphic model 11 in the display area 25 interactively, e.g., in the form of

//Javascript code sample
ActivateRoom (“101”);
ActivateRoom (“102”);
ActivateRoom (“210”).

The function calls initiate an update of the form in which the graphic objects 21-23 are represented in the 3D graphic model 11 in accordance with the respective reservation statuses 17. Consequently, the shares 2 that can be reserved in the displayed 3D graphic model 11 of the item 3 can be recognized as being spatially related, wherein the 3D graphic model 11 can be manipulated in completely arbitrary fashion on the user screen 19, e.g., such that it can be rotated, reversed, zoomed, etc.

The inquiry criteria in the attribute selection area 26 may consist, for example, of the number of rooms, the desired occupancy (number of adults, number of children), desired features such as, e.g., breakfast (“bf”), shower (“sh”), view (“vw”), etc. Although one already has the option of inputting a time window selection in the area 26, this is preferably realized in a separate time window selection area 27.

According to FIGS. 5 and 6, a certain time window can be interactively selected in the time window selection area 27, e.g., in the form of a time line 28. The display of the 3D graphic model 11 in the area 25 is automatically updated in accordance with the selection on the time line 28, by means of corresponding background inquiries of the availability database 10 of the web server 4. Here, the user still has available all conceivable options of spatially rotating, turning, zooming, etc., the 3D graphic model 11 in the display area 25, and the time line 28 also makes it possible to take a “trip through time” in the display of the reservation status-dependent graphic objects 21-23.

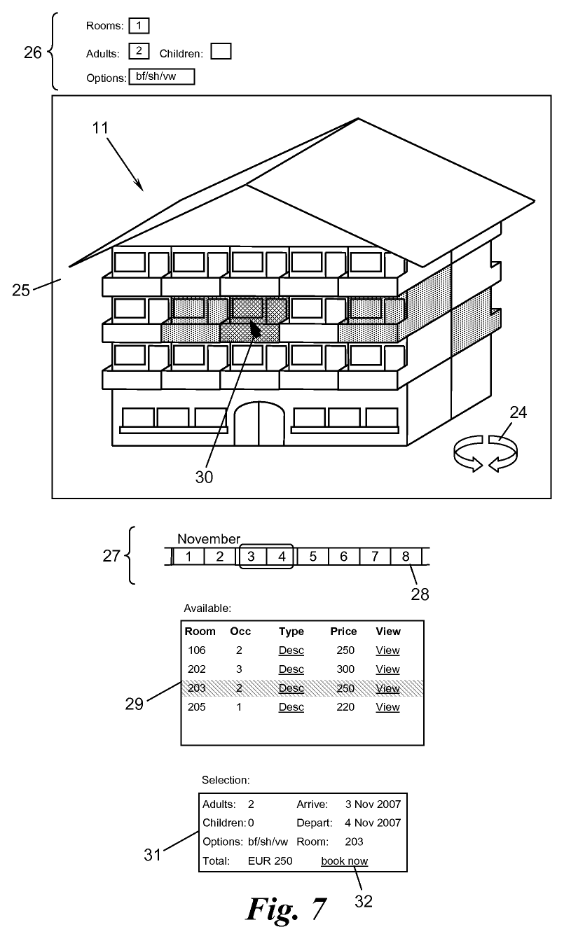

According to FIG. 7, the shares 2 that can be reserved for a set search criteria in the attribute selection area 26 and a certain time window in time window selection area 27 can also be displayed in an area 29 of the user screen 19 in the form of text or lists that are provided with auxiliary information and hyperlinks to other web pages.

The graphic objects 21-23 of the 3D graphic model 11 may also be sensitive to mouse pointers, i.e., the form of their representation can be changed when a mouse pointer 30 is moved over the respective graphic object such that a certain graphic object 21-23, and therefore a certain share 2, can be selected as shown in FIG. 7. The selected share 2 may be highlighted in the auxiliary information area 29 and optionally transferred into a booking mask 31 on the user screen 19. The booking mask 31 may offer, for example, a hyperlink 32 for initiating a subsequent conventional online booking process that ultimately results in a change of the reservation statuses 17 in the list 12 of the availability database 10 as it is known from the state of the art.

The representations on the user screen 19 shown in FIGS. 5-7 may consist, e.g., of Internet browser representations of HTML-coded or XML-coded Internet pages that the web server 4 generates dynamically from its databases 9, 10 and subsequently transmits to the client computer 6. The 3D graphic model 11 is preferably transmitted during the initial call of such an Internet page to the client computer 6; subsequently, only the corresponding availability inquiries are transmitted from the client computer 6 to the web server 4 and the corresponding reservation statuses 17 are transmitted from the web server 4 to the client computer 6 in order to reduce the data traffic, wherein the latter modifies the graphic objects 21-23 accordingly. In an alternative embodiment, however, the 3D graphic model 11 could, if so required, be retransmitted to the client computer 6 in response to each inquiry, wherein the transmitted graphic objects 2 are already modified as a function of the reservation status by the web server 4.

Although the present description referred to the concrete embodiment of a reservation status inquiry of hotel rooms, it goes without saying that the described invention can also be used for all types of shares 2 and items 3, e.g., hotel facilities or wellness areas, conference centers with their conference rooms or usable devices, hospitals with their patient rooms or beds, cruise ships with their cabins, trains with their compartments, vacation home complexes with their vacation homes, stadiums or theaters with their seats, campgrounds with their campsites, parking garages with their parking spaces, etc. Accordingly, the invention is not limited to the embodiments shown, but rather includes all variations and modifications within the scope of the appended claims.

What is claimed is:

1. A system for online reservation inquiries of individual shares of an item, comprising:
a server that makes available a 3D graphic model of the item as well as reservation statuses of the shares of the item for inquiries, and
a client computer for displaying the 3D graphic model on a user screen from an arbitrarily changeable perspective,
wherein the 3D graphic model of the item contains a graphic object for each share that is spatially related to this share in the 3D graphic model,
the server transmits the 3D graphic model of the item and the reservation statuses of the shares of the item to the client computer in response to respective inquiries, and
the manner in which each graphic object is displayed in the arbitrarily changeable perspective of the 3D graphic model is defined by the reservation status of the share to which it is related.

2. The system of claim 1, wherein the item is a hotel and the shares are rooms of the hotel.

3. The system of claim 1, wherein the graphic object related to a share represents this share in the 3D graphic model.

4. The system of claim 1, wherein the graphic object related to a share is spatially arranged directly adjacent to a graphic representation of this share in the 3D graphic model.

5. The system of claim 1, wherein said manner of display of a graphic object concerns the visibility, transparency or color of the graphic object.

6. The system of claim 1, wherein said manner of display is also sensitive to a mouse pointer on the user screen.

7. The system of claim 1, wherein the reservation statuses depend from specific attributes of the shares and are inquirable with respect to one or more of said attributes.

8. The system of claim 1, wherein the reservation statuses are subdivided into time units and are inquirable with respect to selectable time windows of time units.

9. The system of claim 8, wherein the display of the 3D graphic model updates in dependence on a time window inquiry.

10. The system of claim 1, wherein the graphic object displayed on the user screen is sensitive to a mouse pointer in order to initiate a reservation.

11. A method for online reservation inquiries of individual shares of an item, comprising the steps of:
making available a 3D graphic model of the item, which 3D model can be displayed on a user screen from an arbitrarily changeable perspective and contains a graphic object for each share that is spatially related to this share in the 3D graphic model, on a server,
making available reservation statuses of the shares on the server,
transferring the 3D graphic model and the reservation statuses from the server to a client computer in response to respective inquiries,
defining the manner of display of each graphic object in accordance with the reservation status of the share to which it is related, in the client computer, and
displaying the 3D graphic model on the user screen of the client computer from an arbitrarily changeable perspective.

12. The method of claim 11, wherein the item is a hotel and the shares are rooms of the hotel.

13. The method of claim 11, wherein the graphic object related to a share represents this share in the 3D graphic model.

14. The method of claim 11, wherein the graphic object related to a share is spatially arranged directly adjacent to a graphic representation of this share in the 3D graphic model.

15. The method of claim 11, wherein said manner of display of a graphic object concerns the visibility, transparency or color of the graphic object.

16. The method of claim 11, wherein said manner of display is also sensitive to a mouse pointer on the user screen.

17. The method of claim 11, wherein the reservation statuses depend from specific attributes of the shares and are inquirable with respect to one or more of said attributes.

18. The method of claim 11, wherein the reservation statuses are subdivided into time units and are inquirable with respect to selectable time windows of time units.

19. The method of claim 18, wherein the display of the 3D graphic model updates in dependence on a time window inquiry.

20. The method of claim 11, wherein the graphic object displayed on the user screen is sensitive to a mouse pointer in order to initiate a reservation event.

21. A method for online reservation inquiries of individual shares of an item, comprising the steps of:
making available a 3D graphic model of the item, which 3D model can be displayed on a user screen from an arbitrarily changeable perspective and contains a graphic object for each share that is spatially related to this share in the 3D graphic model, on a server,
making available reservation statuses of the shares on the server,
defining the manner of display of each graphic object in accordance with the reservation status of the share to which it is related, in the server,
transferring the 3D graphic model with the graphic objects so defined from the server to a client computer, and
displaying the 3D graphic model on a user screen of the client computer from an arbitrarily changeable perspective.

22. The method of claim 21, wherein the item is a hotel and the shares are rooms of the hotel.

23. A server for online reservation inquiries of individual shares of an item,
the server making available a 3D graphic model of the item that can be displayed on a user screen from an arbitrarily changeable perspective and reservation statuses of the shares of the item for inquiries,
wherein the 3D graphic model of the item contains a graphic object for each share that is spatially related to this share in the 3D graphic model,
wherein the manner in which each graphic object is represented in the 3D graphic model is respectively defined by the reservation status of the share to which it is related.

24. The server of claim 23, wherein the item is a hotel and the shares are rooms of the hotel.

25. The server of claim 23, wherein the graphic object related to a share represents this share in the 3D graphic model.

26. The server of claim 23, wherein the graphic object related to a share is spatially arranged directly adjacent to a graphic representation of this share in the 3D graphic model.

27. A client computer for online reservation inquiries of individual shares of an item,
the client computer receiving, upon a respective inquiry, a 3D graphic model of the item as well as reservation statuses of the shares of the item from a server and displaying the 3D graphic model on a user screen from an arbitrarily changeable perspective,
wherein the 3D graphic model of the item contains a graphic object for each share that is spatially related to this share in the 3D graphic model, and
the manner in which each graphic object is displayed in the arbitrarily changeable perspective of the 3D graphic model is defined by the reservation status of the share to which it is related.

28. The client computer of claim 27, wherein said manner of display is also sensitive to a mouse pointer on the user screen.

29. The client computer of claim 27, wherein the reservation statuses are subdivided into time units and are inquirable with respect to selectable time windows of time units.

30. The client computer of claim 29, wherein the display of the 3D graphic model updates in dependence on a time window inquiry.
